(19) United States
(12) Patent Application Publication
(10) Pub. No.: US 2011/0086948 A1
(43) Pub. Date: Apr. 14, 2011

(54) NYLON-4 COMPOSITE

(75) Inventors: Chae Hwan Hong, Ansan (KR); Do Suck Han, Seongnam (KR)

(73) Assignee: HYUNDAI MOTOR COMPANY, Seoul (KR)

(21) Appl. No.: 12/749,601

(22) Filed: Mar. 30, 2010

(30) Foreign Application Priority Data
Oct. 12, 2009 (KR) 10-2009-00996941

(51) Int. Cl. C08L 1/00

(52) U.S. Cl. 524/35

(57) ABSTRACT

The present invention provides a nylon-4 composite containing a nylon-4 resin as a base material, a natural fiber material, and a maleic anhydride graft poly(ethylene-octene) copolymer resin. The nylon-4 composite of the present invention has high heat resistance and impact resistance to provide mechanical properties equivalent or superior to those of the engineering plastics synthesized from petroleum resources. As a result, the nylon-4 composite of the present invention has as excellent properties as the engineering plastics and is an environment-friendly material, thus being useful to make various industrial components including vehicle engine and chassis components.

### CROSS-REFERENCE TO RELATED APPLICATION

This application claims under 35 U.S.C. §119(a) the benefit of Korean Patent Application No. 10-2009-00996941 filed Oct. 12, 2009, the entire contents of which are incorporated herein by reference.

### BACKGROUND

(a) Technical Field

The present disclosure relates to a nylon-4 based composite which is useful as an engineering plastic. More particularly, it relates to a nylon-4 composite comprising a nylon-4 resin as a base material, a natural fiber material, and a maleic anhydride graft poly(ethylene-octene) copolymer resin.

(b) Background Art

Typically, plastics are light and are excellent in moldability, electrical insulation, coloration, and complexing properties, but there are some limitations in their industrial applicability due to low heat resistance and mechanical strength. Engineering plastics have been developed to solve these drawbacks. They can be used as structural materials, to which general-purpose plastics can be applied. In terms of heat resistance, the engineering plastics can be classified into general-purpose engineering plastics and super engineering plastics having high heat resistance.

One of the general-purpose engineering plastics is a nylon material. There are methods for preparing polyamide resin compositions such as nylon-6 by mixing a polyamide resin with an ethylene-α-olefin copolymer graft-modified with an α, β-unsaturated carboxylic acid to improve low-temperature impact resistance of the polyamide resin (Japanese Patent Publication Nos. 2005-145996, 1997-087475, etc.). However, their impact resistance is not enough to be used as vehicle materials. Moreover, a polyamide hybrid resin composition with the addition of glass fiber to improve the impact resistance, which is prepared according to a method disclosed in Korean Patent Publication No. 10-2007-0102027, is not an environment-friendly resin. Furthermore, although a variety of resin compositions are disclosed in Japanese Patent Publication Nos. 1983-093756, 1992-004248, etc., for example, there are limitations in the application of these resin compositions since they are not environment-friendly and do not have sufficient mechanical properties.

A high heat resistance nylon that can heat resistant at a high temperature (e.g., 260 C° or higher) is demanded for use in various industrial fields such as motor vehicles, electric and electronic industries. It can be prepared by, for example, introducing a branching structure, adding various reinforcing materials, and alloying. Moreover, the demand for the development of nylon materials prepared by using various plant-based biomasses for environmental friendliness increases.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides an environment-friendly nylon-4 composite which has excellent heat resistance and mechanical properties and can be made at a lower cost compared to existing nylon composite materials.

In one aspect, the present invention provides nylon-4 composites comprising: a nylon-4 resin; a nanocellulose; and a maleic anhydride graft poly(ethylene-octene) copolymer resin. The composites show mechanical properties, especially impact resistance properties superior to existing nylon materials. They can be used in various industrial fields including vehicle industry such as to enable to use environment-friendly materials substantially.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is an image of a vehicle engine cover to which a nylon-4 composite of the present invention is applicable;

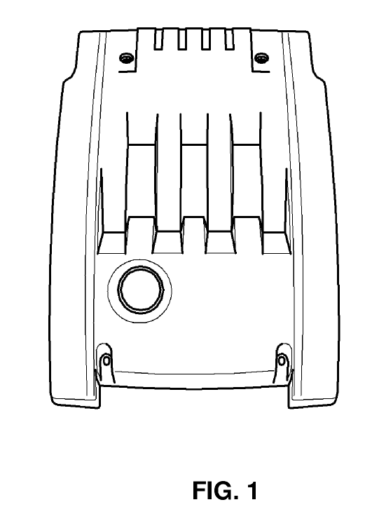

FIG. 2 is an image of a vehicle accelerator pedal to which a nylon-4 composite of the present invention is applicable; and

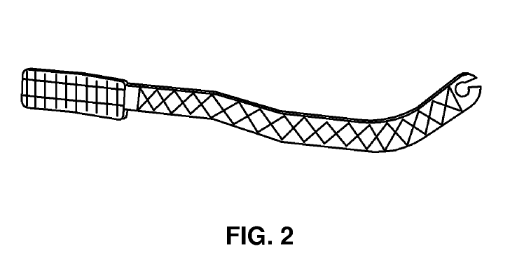

FIG. 3 is an image of a vehicle fuel supply pipe to which a nylon-4 composite of the present invention is applicable.

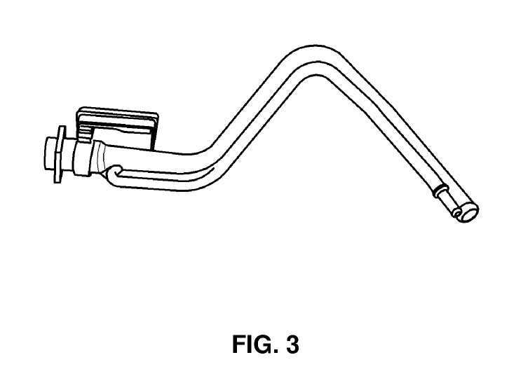

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention provides a nylon-4 composite comprising a nylon-4 resin, a nanocellulose, and a maleic anhydride graft poly(ethylene-octene) copolymer resin.

The nylon-4 resin is a polymer represented by the following formula 1.

—[NH—(CH₂)₃—CO]ᵥ— [Formula 1]

wherein n represents an integer within the range of 20,000 to 150,000.

It can be obtained by the polymerization of pyrrolidone as a chemical derivative of glutamic acid prepared from the fermentation of biomass glucose. Preferably, the nylon-4 resin has a number-average molecular weight of 20,000 to 150,000 and an amine end group concentration of 20 to 60 mmol/kg.

If the number-average molecular weight is less than 20,000, the mechanical properties may be reduced, whereas if it exceeds 150,000, an overload may occur during the process due to an excessive increase in melt viscosity.

If the amine end group concentration is less than 20 mmol/kg, the strength may be reduced due to a reduction in hydrogen bonding, whereas if it exceeds 60 mmol/kg, the moldability may be deteriorated due to excessive hydrogen bonding.

Preferably, the nylon-4 resin is used in an amount of 60 to 80 wt % with respect to the total weight of the composite of the present invention. If the amount of resin used is less than 60 wt %, it cannot be applied to a vehicle engine component due to low heat resistance, which reduces the industrial economic efficiency, whereas if it exceeds 80 wt %, the strength may be reduced due to the high content of nylon-4 resin, which makes it difficult to apply the composite to vehicle components.

The nanocellulose is a material extracted from lignocellulosic and marine plant biomasses, and preferably has a length of 5 to 10 mm and a cross-sectional diameter of 20 to 50 μm.

If the length is less than 5 mm, the effect of increasing the strength may be insignificant, whereas if it exceeds 10 mm, the dispersibility may be deteriorated, which results in non-uniform dispersion, and thus the impact resistance may be reduced.

If the cross-sectional diameter is less than 20 μm, the effect of increasing the strength may be insignificant, whereas if it exceeds 50 μm, the dispersibility may also be deteriorated due to the huge diameter.

Preferably, the nanocellulose is used in an amount of 15 to 35 wt % with respect to the total weight of the composite of the present invention. If the amount of nanocellulose used is less than 15 wt %, the effect of improving the mechanical properties such as impact strength is insignificant due to the low content, whereas if it exceeds 35 wt %, the nanocellulose may be incompletely dispersed in the maleic anhydride graft poly(ethylene-octene) copolymer resin, thus reducing the impact strength.

The maleic anhydride graft poly(ethylene-octene) copolymer resin can be prepared by grafting maleic anhydride to a copolymer of ethylene and octene, polymerized using a metallocene catalyst, by reaction extrusion.

Preferably, the octene is used in an amount of 8 to 12 wt % and at a density of 0.85 to 0.90 g/cm³. If the amount of octene used is less than 8 wt %, the rubber phase properties are reduced to reduce the impact strength properties, whereas if it exceeds 12 wt %, the rubber phase properties are excessive to deteriorate the moldability and reduce the dimensional stability of the final product.

If the concentration of the octene is less than 0.85 g/cm³, the tensile properties may be reduced, whereas if it exceeds 0.90 g/cm³, the molding processability may be deteriorated due to an excessive increase in the density.

Preferably, the maleic anhydride graft poly(ethylene-octene) copolymer resin is used in an amount of 5 to 25 wt %. If the amount of copolymer resin used is less than 5 wt %, the impact strength is significantly reduced, and thus it cannot be applied to a vehicle component, whereas if it exceeds 25 wt %, the tensile strength may be reduced due to an excessive increase in the impact strength, and thus the industrial applications are significantly reduced.

The nylon-4 composite of the present invention may further contain a heat stabilizer, an antioxidant, and a light stabilizer, if necessary, and further contain an organic pigment, an inorganic, and a dye.

For example, the above-mentioned various additives may be added to a predetermined amount of maleic anhydride graft poly(ethylene-octene) copolymer resin and a predetermined amount of nanocellulose, and the resulting mixture is first stirred and mixed by a stirring/mixing device. Then, a predetermined amount of nylon-4 resin and the first stirred mixture are second stirred and mixed, and then melted and mixed at a temperature of 260 to 270° C., thus preparing the nylon-4 composite of the present invention. Here, the nanocellulose is dispersed in the maleic anhydride graft poly(ethylene-octene) copolymer resin, and the resulting maleic anhydride graft poly(ethylene-octene) copolymer resin is dispersed in the nylon-4 resin.

### EXAMPLES

The following examples illustrate the invention and are not intended to limit the same.

### Preparation Example

### Preparation of Nanocellulose

Nanocellulose was prepared by electrospinning method, in which cellulose diacetate was dissolved in a methylene chloride-ethanol mixed solvent, and the resulting solution was sprayed through a nozzle, to which a high voltage of 10 to 50 kV was applied, onto a collection plate spaced a distance of 10 to 25 cm from the nozzle.

### Example 1

A nylon-4 composite was prepared by first stirring/mixing 35 wt % of maleic anhydride graft poly(ethylene-octene) copolymer resin (Fusabond Mn493D manufactured by Dupont, U.S.A) and 15 wt % of nanocellulose in a dry state, second stirring/mixing 50 wt % of nylon-4 resin and the first stirred mixture, and then melting and mixing the resulting mixture at a temperature of 270° C.

### Example 2

A nylon-4 composite was prepared in the same manner as Example 1, except that 25 wt % of maleic anhydride graft poly(ethylene-octene) copolymer resin, 15 wt % of nanocellulose, and 60 wt % of nylon-4 resin were used.

### Example 3

A nylon-4 composite was prepared in the same manner as Example 1, except that 5 wt % of maleic anhydride graft poly(ethylene-octene) copolymer resin, 15 wt % of nanocellulose, and 80 wt % of nylon-4 resin were used.

### Example 4

A nylon-4 composite was prepared in the same manner as Example 1, except that 5 wt % of maleic anhydride graft poly(ethylene-octene) copolymer resin, 5 wt % of nanocellulose, and 90 wt % of nylon-4 resin were used.

### Comparative Example 1

### Nylon-6 Composite

A nylon-6 composite was prepared using 20 wt % of maleic anhydride graft poly(ethylene-octene) copolymer resin and 80 wt % of nylon-6 resin (KN-187 manufactured by Kolon Plastics, Inc., Korea).

### Comparative Example 2

### Nylon-6 Composite

A nylon-6 composite was prepared using 20 wt % of glass fiber (CS-311 manufactured by Keumkang Chemical Co., Ltd., Korea) and 80 wt % of nylon-6 resin.

### Comparative Example 3

### Nylon-6 Composite

A nylon-6 composite was prepared using 25 wt % of maleic anhydride graft poly(ethylene-octene) copolymer resin, 15 wt % of glass fiber, and 60 wt % of nylon-6 resin.

### Comparative Example 4

### Nylon-66 Composite

A nylon-66 composite was prepared in the same manner as Comparative Example 1, except that the nylon-6 resin was substituted for nylon-66 resin (KN-3311 manufactured by Kolon Plastics, Inc., Korea).

### Comparative Example 5

### Nylon-66 Composite

A nylon-66 composite was prepared in the same manner as Comparative Example 2, except that the nylon-6 resin was substituted for nylon-66 resin.

### Comparative Example 6

### Nylon-66 Composite

A nylon-66 composite was prepared in the same manner as Comparative Example 3, except that the nylon-6 resin was substituted for nylon-66 resin.

TABLE 1

| | Examples (wt %) | | | | Comparative Examples (wt %) | | | | | |
|---|---|---|---|---|---|---|---|---|---|---|
| Classification | 1 | 2 | 3 | 4 | 1 | 2 | 3 | 4 | 5 | 6 |
| (A) | 50 | 60 | 80 | 90 | — | — | — | — | — | — |
| (A)-1 | — | — | — | | 80 | 80 | 60 | — | — | — |
| (A)-2 | — | — | — | — | — | — | — | 80 | 80 | 60 |
| (B) | 15 | 15 | 15 | 5 | — | — | — | — | — | — |
| (B)-1 | — | — | — | — | — | 20 | 15 | — | 20 | 15 |
| C | 35 | 25 | 5 | 5 | 20 | — | 25 | 20 | — | 25 |

Component (A): Biomass nylon-4 (Today Plastics, Japan)
Component (A)-1: Petrochemical-based nylon-6 (KN-187, Kolon Plastics, Inc., Korea)
Component (A)-2: Petrochemical-based nylon-66 (KN-3311, Kolon Plastics, Inc., Korea)
Component (B): Nanocellulose (synthesized on a laboratory scale)
Component (B)-1: Glass fiber (CS-311, Keumkang Chemical Co., Ltd., Korea)
Component (C): Maleic anhydride graft poly(ethylene-octene) copolymer resin (Fusabond Mn493D, Dupont, U.S.A)

### Test Example

### Measurement of Properties

Each of the composites prepared in Examples 1 to 4 and Comparative Examples 1 to 6 was injection-molded to obtain a sample in accordance with the following measurement standards (ASTM D 638, ASTM D 256, and ASTM D 648), and the properties of the samples were measured by the methods in accordance with the measurement standards. The test results are shown in the following table 2. The samples for the measurement of tensile properties were dumbbell-type samples, and the samples for the measurement of impact strength had a notch formed thereon.

(1) Measurement of Tensile Properties

The tensile strength values of the samples the measurement prepared in accordance with ASTM D 638 (Standard Test Method for Tensile Properties of Plastics) were measured using a universal testing machine (UTM) [tensile strength (Pa)=maximum load (N)/cross-sectional area (m²) of initial sample].

(2) Measurement of Impact Strength

The impact strength values of the samples prepared in accordance with ASTM D 256 (Standard Test Method for Impact Resistance of Plastics) were measured using an Izod impact tester.

(3) Measurement of Heat Resistance

The heat distortion temperatures of the samples prepared in accordance with ASTM D 648 (Standard Test Method for Deflection Temperature of Plastics Under Flexural Load in the Edgewise Position) were measured using a universal testing machine (UTM).

TABLE 2

| | Classification | | | |
|---|---|---|---|---|
| | Mechanical properties | | | |
| | Tensile | Impact | Heat | |
| | strength | strength | resistance | Biomass |
| Example | (MPa) | (kgf cm/cm) | (° C.) | rate (%) |
| Example 1 | 105 | 10 | 260 | 100 |
| Example 2 | 110 | 15 | 270 | 100 |
| Example 3 | 115 | 16 | 270 | 100 |
| Example 4 | 106 | 8 | 260 | 100 |
| Comp. Example 1 | 100 | 8 | 256 | 20 |
| Comp. Example 2 | 99 | 9 | 255 | 0 |
| Comp. Example 3 | 100 | 8 | 250 | 25 |
| Comp. Example 4 | 101 | 9 | 256 | 20 |
| Comp. Example 5 | 100 | 8 | 257 | 0 |
| Comp. Example 6 | 99 | 9 | 258 | 25 |

As shown in Table 2, it was found that the nylon-4 composites in Examples 1 to 4 of the present invention prepared by mixing the nylon-4 resin obtained by the polymerization of pyrrolidone as a chemical derivative of glutamic acid prepared from the fermentation of biomass glucose, the nanocellulose extracted from lignocellulosic and marine plant biomasses, and the maleic anhydride graft poly(ethylene-octene) copolymer resin exhibited the biomass rate, impact strength, and heat resistance comparable or superior to those of Comparative Examples 1 to 6 including the nylon-6 and nylon-66 composites.

As described above, the nylon-4 composite in accordance with the present invention can be used as materials in various industrial fields including vehicle industry (e.g., for manufacturing vehicle components).

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A nylon-4 composite comprising:
a nylon-4 resin;
a nanocellulose; and
a maleic anhydride graft poly(ethylene-octene) copolymer resin.

2. The nylon-4 composite of claim 1, wherein the nylon-4 resin is contained in an amount of 60 to 80 wt %, the nanocellulose is contained in an amount of 15 to 35 wt %, and the maleic anhydride graft poly(ethylene-octene) copolymer resin is contained in an amount of 5 to 25 wt %.

3. The nylon-4 composite of claim 1, wherein the nanocellulose is dispersed in the maleic anhydride graft poly(ethylene-octene) copolymer resin, and the resulting maleic anhydride graft poly(ethylene-octene) copolymer resin is dispersed in the nylon-4 resin.

4. The nylon-4 composite of claim 1, wherein the nylon-4 resin is obtained by polymerization of pyrrolidone that is a chemical derivative of glutamic acid prepared from fermentation of biomass glucose.

5. The nylon-4 composite of claim 1, wherein the nylon-4 resin has a number-average molecular weight of 20,000 to 150,000 and an amine end group concentration of 20 to 60 mmol/kg.

6. The nylon-4 composite of claim 1, wherein the nanocellulose is a fibrous material obtained from lignocellulosic and marine plant resources.

7. The nylon-4 composite of claim 1, wherein the maleic anhydride graft poly(ethylene-octene) copolymer resin comprises octene in an amount of 8 to 12 wt % and at a density of 0.85 to 0.90 g/cm³.

8. A vehicle component comprising the nylon-4 composite of claim 1.
